(19) United States
(12) Patent Application Publication
(10) Pub. No.: US 2011/0197898 A1
(43) Pub. Date: Aug. 18, 2011

(54) SPIT PREVENTION MASK

(76) Inventor: Pine Yao Chiu, Jinhu Township (TW)

(21) Appl. No.: 12/815,389

(22) Filed: Jun. 14, 2010

(30) Foreign Application Priority Data
Feb. 12, 2010 (TW) 99203270

(51) Int. Cl. A61C 5/14

(52) U.S. Cl. 128/859

(57) ABSTRACT

A spit prevention mask comprises a frame, the covering plate and two support arms. The covering plate is capable of being inserted onto the frame, two support arms can be attached onto the two ends of the frame. wherein with the above mentioned structure, the ear hook of each support arm can be placed around the user's ear, and the covering plate covers the user's mouth, and the separator keeps a predetermined distance between the covering plate and the user's mouth without any contact; therefore, the covering plate prevents spit coming from the user without reducing the clarity of speech of the user, allows facial expressions to be seen, does not affect intake of breath, and exhalations from the user do not cause fogging of the user's eyeglasses.

### BACKGROUND OF THE INVENTION

1. Field of the Invention

The present invention relates to a spit prevention mask, and more particularly to a spit prevention mask which prevents projection of spittle from the user without interfering with the speech of the user or inhaling of the user, while permitting facial expressions to be seen, and further without warm exhalations from the user fogging the user's eyeglasses.

2. Description of the Related Art

Currently, typical masks are made of cotton, linen or non-woven fabrics, and the mask has a respective ear loop at each end. Users can wear the two ear loops over their ears to cover up their mouths and noses, which prevent the projection of spittle from the user.

However, because typical masks tightly cover the user's mouth and nose, such masks still have the following drawbacks:

1. They cause breathing difficulties and are uncomfortable.

2. Warm exhalations coming from the user may cause fogging of the user's eyeglasses, thus effecting both the user's vision and appearance.

3. They reduce the clarity of the speech of the user.

For people who need to wear masks but also need to carry on a lot of conversations in their professions, it is important to have a mask that can prevent spit coming from the user without reducing clarity of speech or affecting the intake of breath, while allowing facial expression to be seen, and preventing the warm exhaled breath coming from the user from fogging the user's eyeglasses so as to avoid adverse effects to the user's vision and appearance.

Therefore, it is desirable to provide a spit prevention mask to mitigate and/or obviate the aforementioned problems.

### SUMMARY OF THE INVENTION

An objective of the present invention is to provide a spit prevention mask.

In order to achieve the above mentioned objective, the spit prevention mask comprises a frame, the covering plate and two support arms.

The frame has a plurality of first slots on an upper edge, a second slot respectively disposed on two ends of the frame, a raised separator formed at a middle position of the frame, and a chin supporting member extending from a lower edge of the separator. The covering plate has a plurality of first engaging members extending from a lower edge and the first engaging members correspond to the first slots of the frame, and when the first engaging members are inserted into the first slots the covering plate is capable of being disposed at the upper edge of the frame. Each support arm has a second engaging member at one end and an ear hook at another end, and the second engaging member is capable of engaging with the second slot of the frame

With the above mentioned structure, the ear hook of each support arm can be placed around the user's ear, the chin supporting member is held against the user's chin such that the covering plate covers the user's mouth, and the separator keeps a predetermined distance between the covering plate and the user's mouth without any contact; therefore, the covering plate prevents spit coming from the user without reducing the clarity of speech of the user, allows facial expressions to be seen, does not affect intake of breath, and exhalations from the user do not cause fogging of the user's eyeglasses.

Other objects, advantages, and novel features of the invention will become more apparent from the following detailed description when taken in conjunction with the accompanying drawings.

### BRIEF DESCRIPTION OF THE DRAWINGS

FIG. 1 is a perspective exploded view of an embodiment of the present invention.

FIG. 2 is a first perspective view of an embodiment of the present invention.

FIG. 3 is a second perspective view of an embodiment of the present invention.

FIG. 4 is a side view and schematic drawing of an adjustable support arm according to an embodiment of the present invention.

FIG. 5 is a cross-sectional view along line I-I shown in FIG. 4.

FIG. 6 is a side view and schematic drawing of a user wearing a mask according to an embodiment of the present invention.

FIG. 7 is a perspective view of a second embodiment according to the present invention.

FIG. 8 is a side view of the second embodiment according to the present invention.

FIG. 9 is a cross-sectional drawing along line II-II shown in FIG. 8.

FIG. 10 is a side view of the second embodiment and a schematic drawing of a user wearing the mask according to an embodiment of the present invention.

FIG. 11 is a local cross-sectional view and schematic drawing of an absorbable paper adhered onto an inner surface of a covering plate according to an embodiment of the present invention.

### DETAILED DESCRIPTION OF THE PREFERRED EMBODIMENT

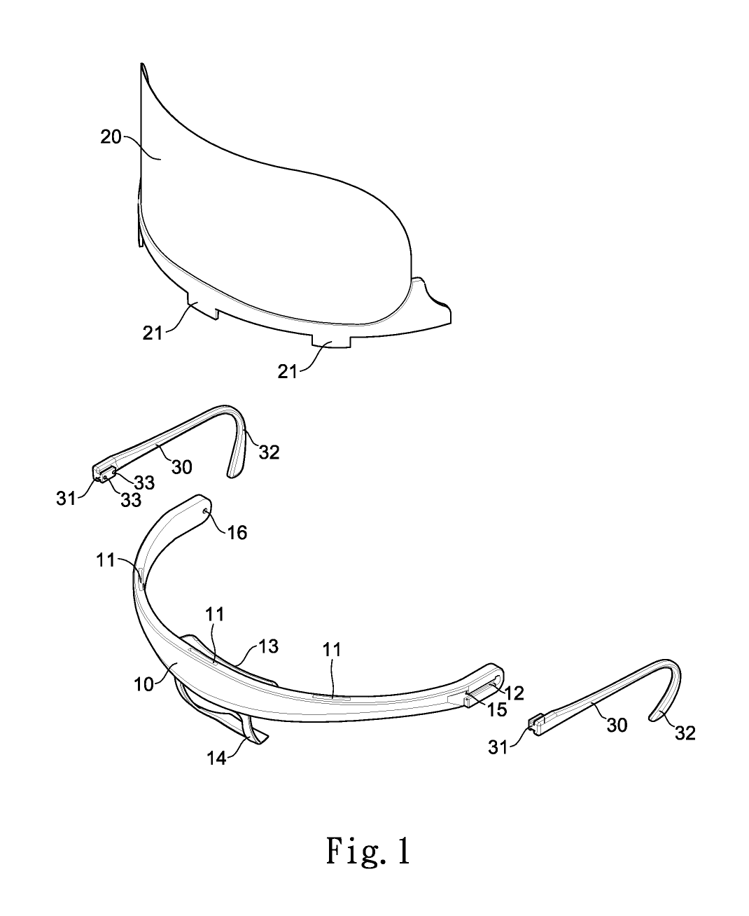

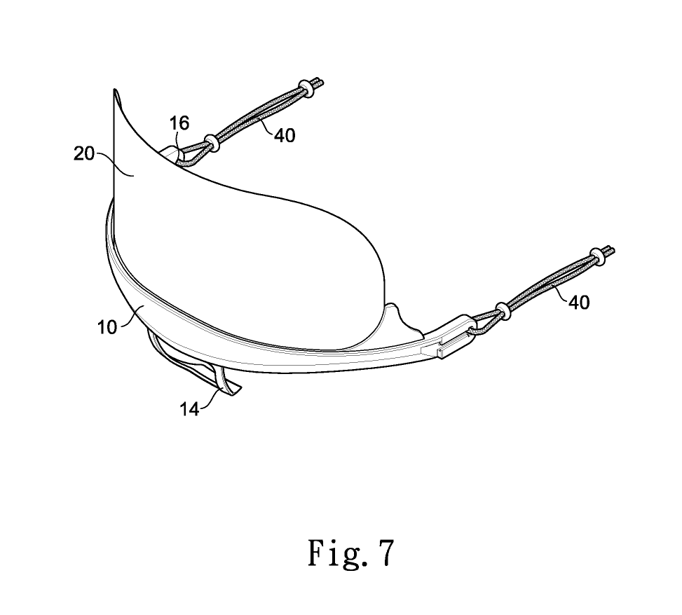

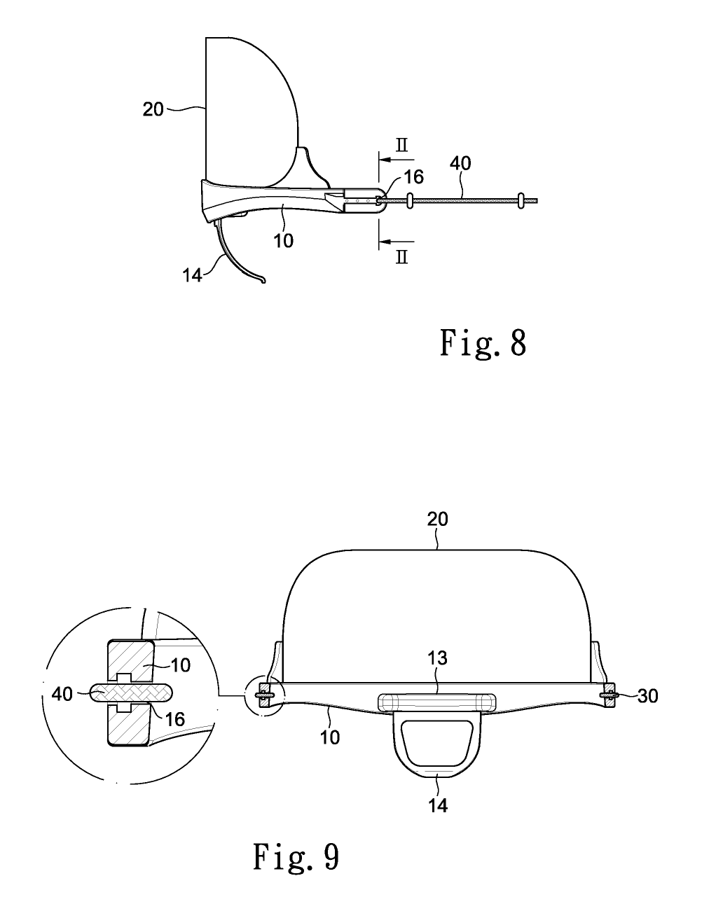

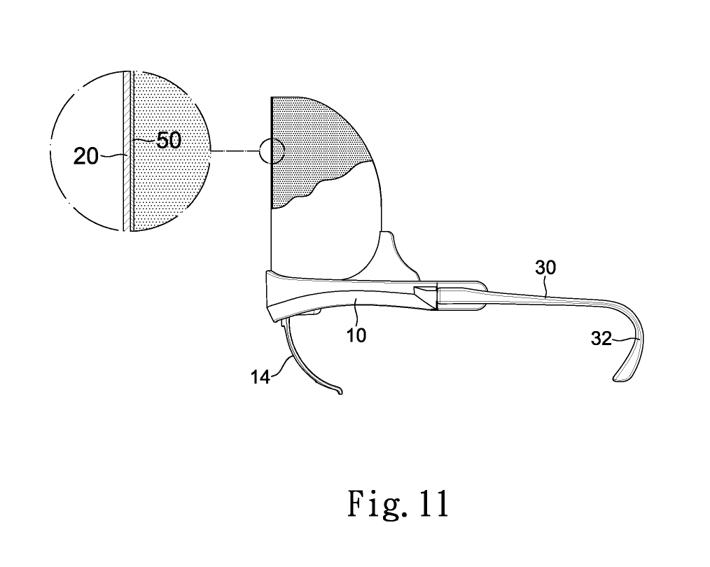

Please refer to FIGS. 1 to 6 for a first embodiment, FIGS. 7 to 10 for a second embodiment, and FIG. 11 for a third embodiment.

As shown in FIG. 1, a first embodiment spit prevention mask comprises a frame 10, a covering plate 20 and two support arms 30.

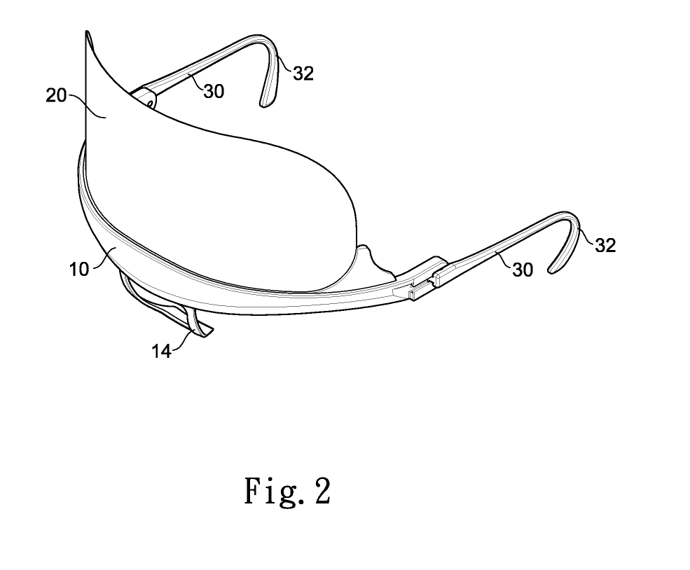

The frame 10 (with reference to FIGS. 2, 3, and 4) is a monolithic structure made of plastic and is formed to match the curves of the human face. The frame 10 has a plurality of first slots 11 on an upper edge, a second slot 12 respectively disposed on two ends of the frame 10, a raised separator 13 formed at a middle position of the frame 10, and a chin supporting member 14 extending from a lower edge of the separator 13.

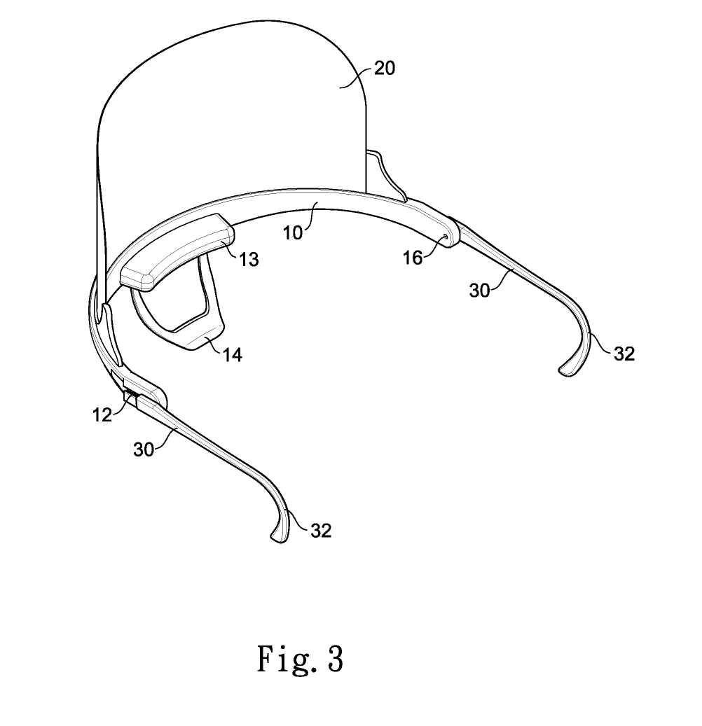

The covering plate 20 (with reference to FIGS. 2 and 3) has a plurality of first engaging members 21 extending from a lower edge, and the first engaging members 21 correspond to the first slots 11 of the frame 10. When the first engaging members 21 are inserted into the respective first slots 11, the covering plate 20 is capable of being placed on the upper edge of the frame 10.

Each support arm 30 (with reference to FIGS. 2, 3, 4 and 5) has a second engaging member 31 at one end and an ear hook 32 at another end, and the second engaging member 32 is capable of engaging with a respective second slot 12 of the frame 10.

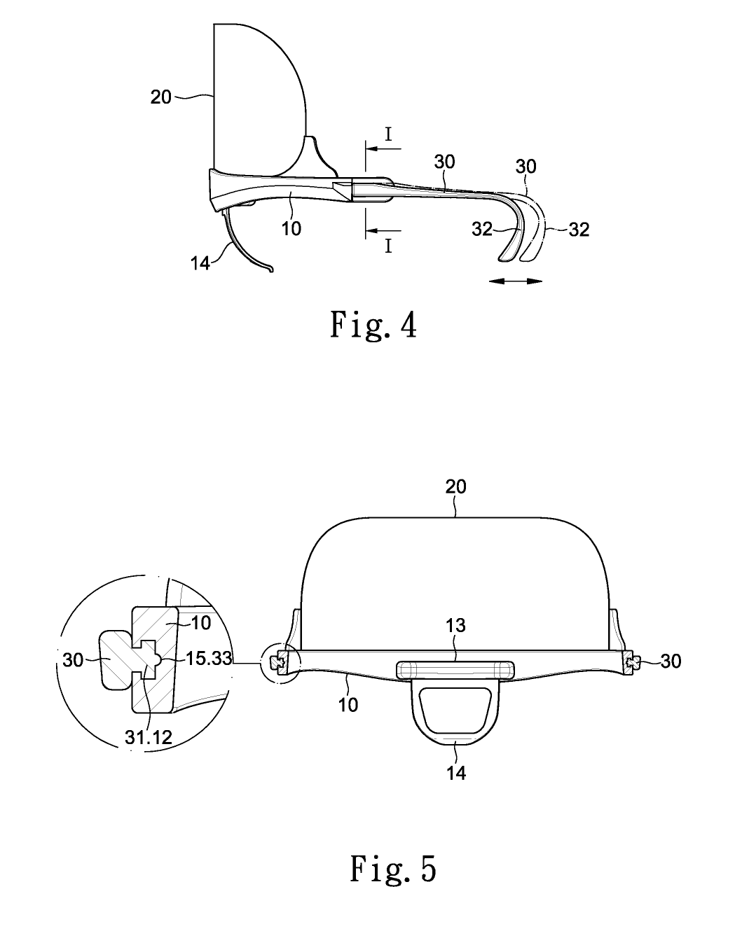

In a preferred embodiment, as shown in FIGS. 1 and 5, the frame 10 has a respective plurality of positioning indentations 15 at the two ends, and at least one positioning protrusion 33 is disposed on a front end of the support arm 30; when the second engaging members 31 of the support arms 30 are engaged with the respective second slots 12 at two ends of the frame 10, the positioning protrusion 33 and the positioning indentations 15 are also engaged together, such that the support arms 30 are firmly attached onto the frame 10 and capable of being adjusted for length (as shown in FIG. 4).

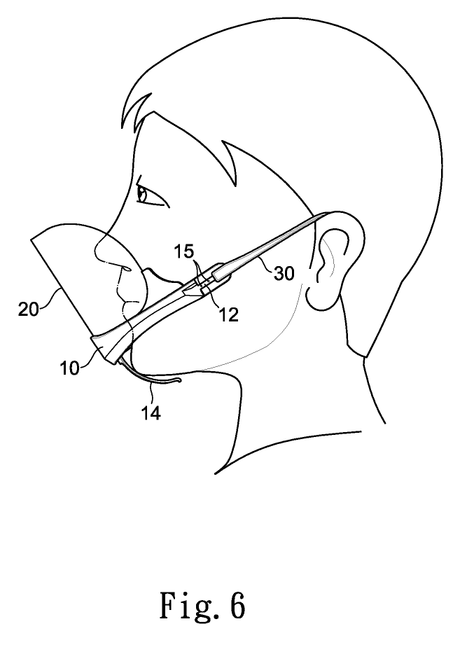

With the above mentioned structure, as shown in FIG. 6, the ear hook 32 of the support arm 30 can be placed around the user's ear, the chin supporting member 14 is held against the user's chin such that the covering plate 20 covers the user's mouth, and the separator 13 keeps a predetermined distance between the covering plate 20 and the user's mouth without any contact. Therefore, the covering plate 20 prevents spit coming from the user without reducing the clarity of speech of the user, allows facial expressions to be seen, does not affect inhalations, and warm exhaled air coming from the user will not fog the user's eyeglasses to affect the user's vision or appearance.

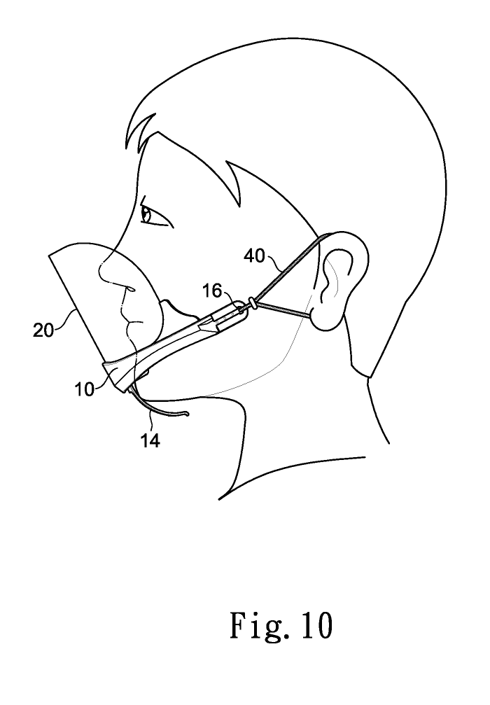

In addition, as shown in FIGS. 7 to 9, in a second embodiment, the frame 10 has a through aperture 16 respectively disposed at the two ends, and a strip 40 may be placed through the through aperture 16 to provide an ear loop for the user, as shown in FIG. 10.

Moreover, as shown in FIG. 11, in another preferred embodiment a water absorbent paper 50 is adhered onto an inner surface of the covering plate 20, which is used for absorbing spit from the user.

Therefore, the mask prevents spit coming from the user without reducing the clarity of the speech of the user, allows facial expressions to be seen, does not affect the intake of breath, and warm exhalations from the user do not cause fogging of the user's eyeglasses. Further, the mask can provide either the support arms or the ear loops for the user to wear.

Although the present invention has been explained in relation to its preferred embodiment, it is to be understood that many other possible modifications and variations can be made without departing from the spirit and scope of the invention as hereinafter claimed.

What is claimed is:

1. A spit prevention mask comprising a frame, a covering plate and two support arms; wherein:
the frame has a plurality of first slots on an upper edge, a second slot respectively disposed on two ends of the frame, a raised separator formed at a middle position of the frame, and a chin supporting member extending from a lower edge of the separator;
the covering plate has a plurality of first engaging members extending from a lower edge and the first engaging members correspond to the first slots of the frame, and when the first engaging members are inserted into the first slots the covering plate is capable of being disposed at the upper edge of the frame; and
each support arm has a second engaging member at one end and an ear hook at another end, and the second engaging member is capable of engaging with the second slot of the frame;
wherein with the above mentioned structure, the ear hook of each support arm can be placed around the user's ear, the chin supporting member is held against the user's chin such that the covering plate covers the user's mouth, and the separator keeps a predetermined distance between the covering plate and the user's mouth without any contact;
therefore, the covering plate prevents spit coming from the user without reducing the clarity of speech of the user, allows facial expressions to be seen, does not affect intake of breath, and exhalations from the user do not cause fogging of the user's eyeglasses.

2. The spit prevention mask as claimed in claim 1, wherein the frame has at least one respective positioning indentation at the two ends, and at least one positioning protrusion is disposed at a front end of the support arm, and when the second engaging members of the support arms are engaged with the second slots at the two ends of the frame, the positioning protrusion and the positioning indentations are also engaged together, such that the support arms are firmly attached onto the frame and capable of length adjustment.

3. The spit prevention mask as claimed in claim 1, wherein a through aperture is respectively disposed at two ends of the frame, and a strip can be placed through the through each aperture to provide an ear loop.

4. The spit prevention mask as claimed in claim 1, wherein a water absorbable paper is adhered onto an inner surface of the covering plate, which is used for absorbing spit from a user.
